(19) United States
(12) Patent Application Publication
(10) Pub. No.: US 2011/0022316 A1
(43) Pub. Date: Jan. 27, 2011

(54) EVASIVE AUTOPILOT SYSTEM FOR VESSELS

(76) Inventor: Juan Mariano Bendito Vallori, Baleares (ES)

Correspondence Address: OSTROLENK FABER GERB & SOFFEN, 1180 AVENUE OF THE AMERICAS, NEW YORK, NY, 100368403, US

(21) Appl. No.: 12/918,335

(22) PCT Filed: Jan. 28, 2009
(86) PCT No.: PCT/ES2009/070013

§ 371 Date: Oct. 1, 2010

(30) Foreign Application Priority Data
Feb. 19, 2008 (ES) P200800447
Oct. 17, 2008 (ES) P200802936

(51) Int. Cl. G08G 3/02; G01S 13/93; G05D 1/02; G01P 5/06; G01W 1/00

(52) U.S. Cl. 701/301; 73/861.85; 73/170.05

(57) ABSTRACT

The present disclosure relates to an autopilot device (2) which actuates, at least, on the course controls (3) of the bearing vessel (6), and which comprises an electronic evasion module (4) capable of generating evasive manoeuvre orders for the autopilot device (2) in the event of taking a collision course; as well as a radar (7) connected to said an electronic evasion module (4) in order to detect the existence of obstacles (5, 5′) which generate collision courses, as well as comprising a laser telemeter (16) and an AIS system (17), to support the radar (7), and means of detecting (18) the turning degrees of the steering wheel, as well as sensors (19) that measure the revolutions of the engine.

### OBJECT OF THE INVENTION

The present invention relates to the field of marine navigation.

The object of the invention is an autopilot system for vessels, which permits the evasion of various types of obstacles.

### BACKGROUND OF THE INVENTION

Currently autopilot devices are known that are capable of maintaining the course by actuating on, at least, the course controls of the vessel.

These autopilots adopt different formats, and are even adaptable to vessels not configured for them, by means of a pulley wheel that acts on the steering wheel.

They are frequently connected to geographic positioning devices (GPS) in order to correct deviations in the desired course.

Nevertheless, automatic systems are not known that are capable of identifying and correcting collision courses, with collision courses meaning those where the course and velocity of the vessel dangerously decrease the distance with respect to any obstacle; as current autopilots are limited to staying on the course programmed, and at most, to correcting it if it detects deviations with respect to the destination point, so even in these times collisions and overtakings continue to occur between vessels, with the consequent economic losses, and even losses of lives, and harmful effects for the environment.

### DESCRIPTION OF THE INVENTION

The evasive autopilot system for bearing vessels according to the invention has an optimal make-up which resolves the drawbacks described.

In accordance with the invention, the system comprises an autopilot device which actuates, at least, on the course controls of a vessel bearing the system of the invention; an electronic evasion module capable of identifying collision courses and generating evasive manoeuvre orders for the autopilot device in this case; and a radar connected to said electronic evasion module to inform it of the existence of obstacles which create collision courses.

When it detects a collision course with a static object or in motion object, the electronic evasion module generates control orders for the autopilot device, which will modify, at least, the course of the bearing vessel to avoid the collision, subsequently re-establishing, calculating according to the safety parameters introduced if it has open course of ships and obstacles which could produce collisions or even grounding.

Additionally, the system of the invention comprises that the autopilot device implements an actuator on the course control and/or speed of the bearing vessel, in order to generate orders on these controls in the event of evasive manoeuvre. This permits the system to not only change the course, but also the speed and even, if necessary, reverse the direction without stopping the driving/propulsion systems, according to the parameters of safety introduced, in order to reduce the collision speed and/or prevent the collision.

The invention can additionally incorporate an automatic identification system (AIS), as well as a laser telemeter, and complementary systems to the radar. Both the AIS system and the laser telemeter are connected to the electronic evasion module, which in turn is connected to the radar.

The AIS system permits a bearing vessel to communicate its position to other vessels, as well as other pertinent information, such as identifying information, so that other vessels learn about the proximity of an obstacle and know that they are dealing with a navigation vehicle and can identify it.

A laser telemeter is a device which permits one to find out the distance between the bearing vessel and an obstacle, by means of a laser beam.

The system of the invention can additionally incorporate means of detecting the turning radius of the steering wheel and means of measuring the revolutions of the engine, connected to the electronic evasion module to transmit the course of the bearing vessel and the rotational speed of the motor.

When it is time to gather information and execute the orders created, the system of the invention considers implementing the different elements which are exclusively intended to make it up for, or considers the possibility of using some of those which may exist in the bearing vessel previously (for example existing radar, or the foghorn, etc).

### DESCRIPTION OF THE DRAWINGS

In order to complement the description being carried out and with the purpose of helping towards a better understanding of the characteristics of the invention, in accordance with a preferred example of practical embodiment thereof, a set of drawings is attached as an integral part of said description, wherein the following, in an illustrative and non-limitative character, has been represented:

FIG. 1 shows a schematic view of a vessel bearing the system of the invention, whose course presents risks of collision with another vessel or with the coast.

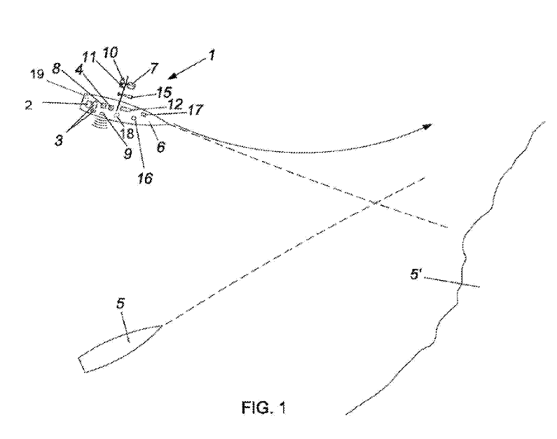

FIG. 2 shows a schematic view of bearing vessel equipped with the system of the invention.

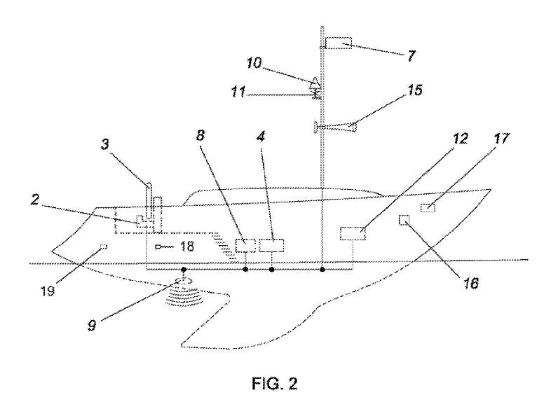

### PREFERRED EMBODIMENT OF THE INVENTION

The evasive autopilot system (1) for vessels (6) bearing the invention comprises an autopilot device (2) which actuates, in this example of the invention, on the course controls (3) and speed of the bearing vessel (6).

This autopilot device (2) is connected to an electronic evasion module (4), which implements the electronics and the programming necessary to identify that it is on a collision course, and generates evasive manoeuvre orders for the autopilot device (2) in this case. The detection of obstacles, both mobile (5), as well as geographic (5′) or submerged (not represented) can be static and dynamic, i.e., it can be capable of detecting collision courses with static objects, or objects in motion depending on the course and speed thereof.

To do this, the electronic evasion module (4) knows and previously determines the course parameters and speed of the vessel and locates mobile (5), geographic (5′) and/or submerged obstacles which could get in the way of said course depending on the speed of the vessel itself and the speed thereof, calculating whether there is risk of collision. It can be programmed, depending on the characteristics of the bearing vessel (6) the time delay and the minimum distance to initiate the evasive manoeuvre. Both the acquisition of information and the calculation of the different situations are carried out sequentially and repetitively several times per second.

The programming of the electronic evasion module (4) also implements an decision making algorithm according to the international navigation regulations relating to passage rights, evasive course determination and warning signal generation of decided manoeuvres, so that it is capable of waiting for the manoeuvre of another vessel or moving obstacle (5) if it has rite of passage, before generating the instructions for the evasive manoeuvre, which in any case will be generated and executed if the other vessel continues on the collision course.

The detection of moving (5), (geographic (5′) and/or submerged obstacles is done automatically, mainly by means of a radar (7) associated with the electronic evasion module (4). It is proposed that the radar (7) can be complemented with the help of a laser telemeter (16) to detect the distance to which the obstacle (5, 5′) is located and, in the case of the AIS systems (17), to send and receive signals from other vessels and be able to identify them.

The course of the vessel itself, either of the autopilot device (2) if this is prepared for it, or of the geographic positioning system (8) associated to the electronic evasion module (4), such as a GPS. Said geographic positioning system (8) can additionally incorporate cartography, which will permit the electronic evasion module (4), not only to establish the position of the bearing vessel (6) and its course, but also to determine the existence of geographic obstacles (5′) (cliffs, reefs, etc), in order to take them into account when generating an evasive manoeuvre, or simply to determine if there is a risk of collision therewith in the normal manoeuvre, generating evasive manoeuvre orders in this case.

The system (1) can also comprise a sonar (9) associated with the electronic evasion module (4), which will inform it of the existence of sea bottoms or submerged obstacles which might be dangerous during the evasive manoeuvres or normal manoeuvres, so that the electronic evasion module (4) can generate the precise orders so that the autopilot device (2) corrects the course and/or speed in order to avoid them or rule out the evasive manoeuvres which could be compromised by this cause.

In the same fashion, the system (1) of the invention can comprise a weather vane (10) and an anemometer 811) associated to the electronic evasion module (4), in order to know the direction and speed of the wind and take these parameters into account when generating an evasive manoeuvre, for example to give more force to the steering wheel to compensate for drifting due to wind in the deadworks of the bearing vessel (1).

The system (1) of the invention can also comprise a plotter (12) associated with the electronic evasion module (4), to draw up the original courses and/or the evasive manoeuvre courses.

It can also comprise an invasive actuation indicator, not represented, which can be, for example, a sound emitter and/or a light indicator, which notifies of the beginning and the end of each said manoeuvre, and can also comprise an exterior connection to activate the foghorn (15) of the bearing vessel, with the purpose of notifying of said manoeuvres to other vessels according to the international regulations.

Once the risk of collision has been detected, the electronic evasion module (4) determines the parameters of the course that must be used to avoid the collision. To calculate said course parameters, the electronic evasion module (4) can additionally consider the information received from measurement sensors (19) of the engine revolutions (tachometer) and means of detecting (18) the degrees turned by the steering wheel, as well as the speed of the bearing vessel (6).

In any case, the definitive control of the bearing vessel (6) by the crew is ensured by means of the availability of an emergency stop control, as well as an activation and deactivation control, not represented. In both cases, these can be remote controls so that control is maintained at all times, including in the case of long bearing vessels (6).

With regard to the peripheral elements of the system (1): radar (7), geographic positioning system (8), plotter (12), sonar (9), anemometer (11) and weather vane (10), they can be exclusively dedicated to the system (1) of the invention, or can be elements shared with other systems on the ship, so that the invention can also consider the use for the system (1) of the invention, of the equipment of this type previously existing on the bearing vessel (6).

In the same manner, if one wishes to use an existing autopilot device (2), which only actuates on the control of the course of the bearing vessel (6), the system of the invention is also provided with the implementation of an actuator, not represented, on the gear and speed controls, actuator which will be conveniently associated to the electronic evasion module (4). Then the existing autopilot device (2) will take charge of the course control, and this actuator will take charge of the gear and speed control.

1. Evasive autopilot system for bearing vessels, which comprises:
an autopilot device which actuates, at least, on the course controls of the bearing vessel;
an electronic evasion module capable of generating evasive manoeuvre orders for the autopilot device in the event of taking a collision course; and
a radar connected to said electronic evasion module in order to detect the existence of mobile, geographic and/or submerged obstacles which generate collision courses,
wherein it additionally comprises an activation connection of a sound signal emitting system of the bearing vessel to warn other vessels of the evasive manoeuvres.

2. Evasive autopilot system for bearing vessels, according to claim 1, wherein the autopilot device is configured so that it is capable of transmitting the ship's own course to the electronic evasion module.

3. Evasive autopilot system for bearing vessels according to claim 1, wherein it additionally comprises a geographic positioning system associated to the electronic evasion module in order to provide said electronic evasion module with the position and course of the bearing vessel.

4. Evasive autopilot system for bearing vessels according to claim 3, wherein the geographic positioning system implements cartographies, in order to inform the electronic evasion module of the existence of geographic obstacles.

5. Evasive autopilot system for bearing vessels according to any of the previous claims claim 1, wherein it incorporates an actuator on the gear and speed controls of the bearing vessel.

6. Evasive autopilot system for bearing vessels according to claim 1, wherein it additionally comprises a sonar associated to the electronic evasion module, in order to inform said electronic evasion module of the existence of submerged obstacles.

7. Evasive autopilot system for bearing vessels according to claim 1, wherein it additionally comprises a weather vane and an anemometer associated to the electronic evasion module, adapted to inform said electronic evasion module of the speed and force of the wind.

8. Evasive autopilot system for bearing vessels according to claim 1, wherein it additionally comprises a plotter associated to the electronic evasion module, in order to draw up the original courses and/or the evasive manoeuvre courses.

9. Evasive autopilot system for bearing vessels according to claim 1, wherein it additionally comprises an evasive actuation indicator, which informs of the beginning and end of an evasive manoeuvre.

10. Evasive autopilot system for bearing vessels according to claim 9, wherein the evasive actuation indicator is selected from between:
a sound emitter, and
a light indicator.

11. Evasive autopilot system for bearing vessels according to claim 1, wherein it incorporates a control for its activation and deactivation.

12. Evasive autopilot system for bearing vessels according to claim 1, wherein it incorporates an emergency stop control for the bearing vessel.

13. Evasive autopilot system for bearing vessels according to claim 1, wherein the electronic evasive module implements a decision making algorithm according to the international navigation regulations relating to rites of passage, determination of evasion courses and generation of warning signals of decided manoeuvres, which is capable of waiting for the manoeuvre of another vessel or moving obstacle if it has rite of passage, before generating the evasive manoeuvre instructions, generating said evasive manoeuvre in any case and executing it if the other vessel continues along the collision course.

14. Evasive autopilot system for bearing vessels according to claim 1, wherein it additionally comprises:
A laser telemeter (16) which supports the radar,
an AIS system which supports the radar and
means of detecting the engine revolutions of the bearing vessel, and
measurement sensors of the turning degrees of the steering wheel of the bearing vessel.
